(19) United States
(12) Patent Application Publication
(10) Pub. No.: US 2025/0344190 A1
(43) Pub. Date: Nov. 6, 2025

(54) METHOD AND APPARATUS OF BEAM DETERMINATION

(71) Applicant: Lenovo (Beijing) Limited, Beijing (CN)

(72) Inventors: Hongmei Liu, Beijing (CN); Yuantao Zhang, Beijing (CN); Zhi Yan, Beijing (CN); Ruixiang Ma, Beijing (CN); Haiming Wang, Beijing (CN)

(73) Assignee: Lenovo (Beijing) Limited, Beijing (CN)

(21) Appl. No.: 18/854,311

(22) PCT Filed: Apr. 8, 2022
(86) PCT No.: PCT/CN2022/085957

§ 371 Date: Oct. 4, 2024

(51) Int. Cl. H04W 72/044; H04B 7/06; H04W 72/23; H04W 74/0833

(52) U.S. Cl. CPC H04W 72/044; H04B 7/0626; H04W 72/23; H04W 74/0833

(57) ABSTRACT

Embodiments of the present application are related to a method and apparatus of beam determination. According an embodiment of the present application, an exemplary method includes: receiving information indicating mapping between a set of resources in at least one of time and frequency domain for PDCCH and a set of spatial domain filters; and determining at least one of the following based on the information: a first spatial domain filter for a first resource for PDCCH between the RAN node and a second RAN node; or a second spatial domain filter for a second resource for PDCCH between the RAN node and a third node.

### TECHNICAL FIELD

Embodiments of the present application generally relate to wireless communication technology, especially to a method and apparatus of beam determination.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In legacy release, to enable transmission and/or reception in a link between a base station (BS), e.g., gNB and a user equipment (UE), the gNB will indicate the UE a downlink (DL) reception or uplink (UL) transmission beam, which may be based on measurement and reporting on reference signals (RS) s to match channel status, e.g., channel state information-reference signal (CSI-RS), synchronization signal (SS)/physical broadcast channel (PBCH) block (SSB), or sounding reference signal (SRS) etc. When there is a repeater between the gNB and the UE, for each SSB, CSI-RS and SRS, the repeater needs to determine at least one of the reception beam and transmission beam for a link between the gNB and the repeater and determine at least one of the transmission beam and reception beam for a link between the repeater and the UE. For example, in a random access channel (RACH) procedure, there is no indication on the beam selected by the UE from the gNB to the repeater, and thus the repeater does not know the beam selected by the UE. Accordingly, the repeater cannot determine the reception beam and transmission beam for the link between the gNB and the repeater and the transmission beam and reception beam for the link between the repeater and the UE. A similar issue also exists in a beam failure recovery (BFR) procedure.

Thus, how to determine RSs or beam(s) of a repeater for the link between the gNB and repeater and the link between the repeater and the UE should be solved.

### SUMMARY OF THE DISCLOSURE

One objective of the present application is to provide a method and apparatus of beam determination, e.g., a method and apparatus of beam determination for a link between gNB and repeater or a link between repeater and UE or the like, e.g., in the RACH procedure and BFR procedure.

According to some embodiments of the present application, an exemplary RAN node e.g., a repeater includes: a transceiver; and a processor coupled to the transceiver, wherein the processor is configured to: receive, via the transceiver, information indicating mapping between a set of resources in at least one of time and frequency domain for physical downlink control channel (PDCCH) and a set of spatial domain filters; and determine at least one of the following based on the information: a first spatial domain filter for a first resource for PDCCH between the RAN node and a second RAN node of the set of resources; or a second spatial domain filter for a second resource for PDCCH between the RAN node and a third node of the set of resources.

In some embodiments of the present application, the first spatial domain filter and the second spatial domain filter are determined based on a same spatial domain filter of the set of spatial domain filters. In some other embodiments of the present application, the first spatial domain filter and the second spatial domain filter are determined based on different spatial domain filters of the set of spatial domain filters respectively.

In some embodiments of the present application, a spatial domain filter of the spatial domain filter sets is associated with a SSB, a CSI-RS resource or a SRS resource.

In some embodiments of the present application, the information further indicates a starting boundary and a period of the mapping.

In some embodiments of the present application, the PDCCH is associated with a search space of random access response or a recovery search space.

In some embodiments of the present application, a resource of the set of resources is a PDCCH monitoring occasion.

In some embodiments of the present application, a starting boundary of the mapping is a first PDCCH monitoring occasion in a search space of random access response and is at least 1 symbol after a resource occasion (RO) associated with a RS with a smallest index of a set of RSs associated with the set of spatial domain filters. In some other embodiments of the present application, a starting boundary of the mapping is a first PDCCH monitoring occasion in the recovery search space, and is at least 4 symbols after a RO associated with a RS with a smallest RS index of a candidate RS list associated with the set of spatial domain filters.

In some embodiments of the present application, different resources of the set of resources are mapped to different spatial domain filters by mapping the set of resources to a set of RSs associated with the set of spatial domain filters, and the information indicates mapping between the set of resources and the set of spatial domain filters. Each resource of the set of resources within a period of the mapping is mapped to a corresponding RS in sequence, and the set of RSs is configured in system information block 1 (SIB1), radio resource control (RRC) or a candidate RS list.

In some embodiments of the present application, in the case that there is more than one PDCCH monitoring occasion after a first RO associated with a first RS of a set of RSs associated with the set of spatial domain filters and before a second RO associated with a second RS of the set of RSs, a PDCCH monitoring occasion of the more than one PDCCH monitoring occasion with a lowest time domain index is mapped to the first RS. Other PDCCH monitoring occasion of the more than one PDCCH monitoring occasion except for the PDCCH monitoring occasion with the lowest time domain index is also mapped to the first RS or unused.

In some embodiments of the present application, the set of resources is mapped to the set of spatial domain filters by mapping a set of control resource sets (CORESET) s for PDCCH to a set of RSs associated with the set of spatial domain filters, and the information indicates the mapping between the set of CORESETs and the set of RSs. In some other embodiments of the present application, the set of resources is mapped to the set of spatial domain filters by mapping a set of search spaces for PDCCH to a set of RSs associated with the set of spatial domain filters, and the information indicates the mapping between the set of search spaces and the set of RSs. In some yet other embodiments of the present application, the set of resources is mapped to the set of spatial domain filters by mapping a set of control channel elements (CCE)s for PDCCH candidates to a set of RSs associated with the set of spatial domain filters, and the information indicates the mapping between the PDCCH candidates and the set of RSs, wherein the mapping is determined by a CCE with a lowest index of a corresponding PDCCH candidate.

In some embodiments of the present application, the information is a beam pattern received in a signaling, and the signaling is SIB1, RRC, medium access control (MAC) control element (CE) or group common downlink control information (DCI), and the beam pattern contains one or more spatial domain filters. According to some embodiments of the present application, start of the mapping is configured, or is a slot boundary of the signaling, or is a nearest slot boundary, a nearest PDCCH monitoring occasion, a nearest CORESET or a nearest search space after receiving the signaling. According to some embodiments of the present application, the set of spatial domain filters is mapped to corresponding PDCCH monitoring occasions or corresponding CORESETs or corresponding search spaces one by one in sequence and cyclically according to the beam pattern.

In some embodiments of the present application, the processor is configured to perform at least one of the following: determine a third spatial domain filter for at least one of physical downlink shared channel (PDSCH), Msg B, or Msg 4, or physical uplink shared channel (PUCCH) in response to Msg B or Msg 4 reception between the node and the second node based on the first spatial domain filter, wherein the first domain filter is a spatial domain filter of a detected PDCCH reception in a search space of random access response; or determine a fourth spatial domain filter for at least one of PDSCH, or Msg B, or Msg 4, or PUCCH in response to Msg B or Msg 4 transmission between the node and the third node based on a spatial domain filter of the second spatial domain filter, wherein the second spatial domain filter is a detected PDCCH transmission in the search space of random access response.

In some embodiments of the present application, the processor is configured to perform at least one of the following: determine a third spatial domain filter for one or more of CORESET #0, all CORESETs on secondary cells (Scells), PUCCH on a primary cell (Pcell), and all PUCCH on a PUCCH-Scell for transmission between the node and the second node based on the first spatial domain filter, wherein the first spatial domain filter is a spatial domain filter of detected PDCCH transmission in the recovery search space; or determine a fourth spatial domain filter for one or more of CORESET #0, all CORESETs on Scells, PUCCH on Pcell, and all PUCCH on a PUCCH-Scell for reception between the node and the third node based on the second spatial domain filter, wherein the second spatial domain filter is a spatial domain filter of detected PDCCH reception in the recovery search space.

In some embodiments of the present application, the processor is configured to receive a signaling configuring at least one of a starting boundary of the mapping, a period or an offset of the mapping. The at least one of the starting boundary, the period or the offset is in unit of slot of ms or slot of s.

In some embodiments of the present application, a resource in time domain of the set of resources is one or multiple downlink symbols, uplink symbols, orthogonal frequency division multiplexing (OFDM) symbols or single carrier-frequency division multiple access (SC-FDMA) symbols.

In some embodiments of the present application, the starting boundary is a slot boundary of receiving a signaling indicating the information, or is a nearest downlink symbol, or uplink symbol, or an OFDM symbol or a SC-FDMA symbol after receiving the signaling.

In some embodiments of the present application, the resource is one or more symbols, or one or more slots in time domain.

In some embodiments of the present application, a resource of the set of resources indicates no transmission or reception.

Some embodiments of the present application provide another RAN node, e.g., a gNB, which includes: a transceiver; and a processor coupled to the transceiver, wherein the processor is configured to: determine information indicating mapping between a set of resources in at least one of time and frequency domain for PDCCH and a set of spatial domain filters; transmit the information via the transceiver; and determine at least one of the following based on the information: a first spatial domain filter for a first resource for PDCCH between the RAN node and a first RAN node of the set of resources; or a second spatial domain filter for a second resource for PDCCH between the first RAN node and a third node of the set of resources.

Given the above, embodiments of the present application provide a technical solution of beam determination for a RAN node, e.g., a repeater, especially in the RACH procedure and BFR procedure, and thus will facilitate the deployment and implementation of the NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 illustrates a schematic diagram of an exemplary wireless communication system in a non-multi-TRP scenario according to some embodiments of the present application.

FIG. 3 illustrates a schematic diagram of an exemplary wireless communication system in a multi-TRP scenario according to some other embodiments of the present application.

FIG. 4 is a flow chart illustrating an exemplary procedure of a method of beam determination according to some embodiments of the present application.

FIG. 5 is a schematic diagram illustrating an exemplary beam determination procedure according to some embodiments of the present application.

FIG. 6 is a schematic diagram illustrating an exemplary beam determination procedure based on beam pattern according to some embodiments of the present application.

FIG. 7 is a schematic diagram illustrating an exemplary beam determination procedure based on beam pattern according to some other embodiments of the present application.

FIG. 8 is a schematic diagram illustrating an exemplary beam determination procedure based on beam pattern according to some yet other embodiments of the present application.

FIG. 9 is a schematic diagram illustrating an exemplary beam determination procedure based on beam pattern according to some yet other embodiments of the present application.

FIG. 10 illustrates a block diagram of an exemplary apparatus of beam determination according to some embodiments of the present application.

FIG. 11 illustrates a block diagram of an exemplary apparatus of beam determination according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

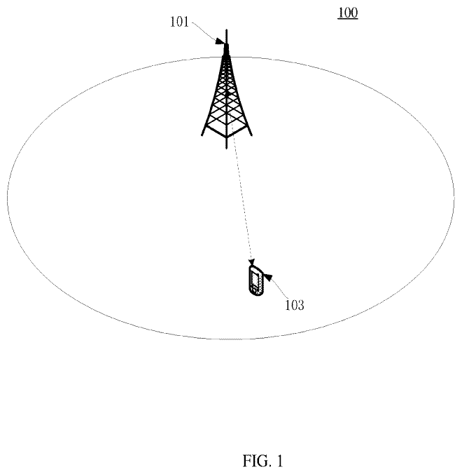

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one TRP (or panel), i.e., in a single-TRP scenario or more TRPs (or panels), i.e., a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 103.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

To enhance the coverage area of a BS, relay nodes, such as repeaters may be deployed in a wireless communication system, which can improve the throughput of a mobile device in low signal quality, e.g., a UE that locates in a coverage hole or far from the BS.

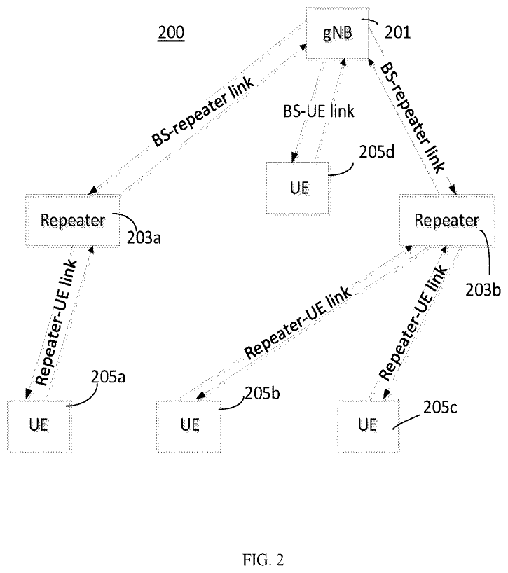

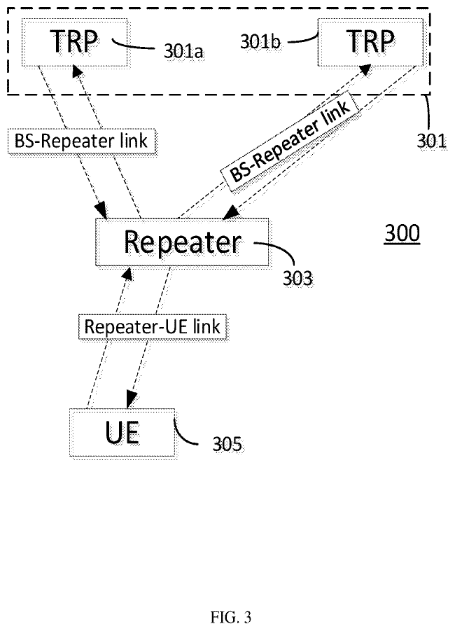

FIG. 2 and FIG. 3 respectively illustrate an exemplary scenario of a wireless communication system with repeaters, wherein FIG. 2 illustrates a schematic diagram of an exemplary wireless communication system 200 in a non-multi-TRP scenario according to some embodiments of the present application, and FIG. 3 illustrates a schematic diagram of an exemplary wireless communication system 300 in a multi-TRP scenario according to some other embodiments of the present application.

Referring to FIG. 2, in the exemplary wireless communication system 200, there are multiple nodes, e.g., a gNB 201, a first repeater 203a, a second repeater 203b, a first UE 205a, a second UE 205b, a third UE 205c and a fourth UE 205d. The gNB 201 may be configured with a single TRP or not. The first repeater 203a is connected with the gNB 201 and the first UE 205a, the second repeater 203b is connected with the gNB 201 and the second UE 205b and the third UE 205c. A link between a BS, e.g., the gNB 201 and a repeater, e.g., the first repeater 203a or the second repeater 203b can be referred to a BS-repeater link (or gNB-repeater link), a link between a repeater, e.g., the first repeater 203a and a UE, e.g., the first UE 205a can be referred to a repeater-UE link; and a link between a BS, e.g., the gNB 201 and a UE, e.g., the fourth UE 205d can be referred to as a BS-UE link (or gNB-UE link).

Persons skilled in the art should well know that each BS, e.g., the gNB 201 can connect with one or more repeaters, e.g., the first repeater 203a and second repeater 203b, and one or more UEs, e.g., the first UE 205a, the second UE 205b, the third UE 205c and the fourth UE 205d; and each repeater, e.g., the first repeater 203a and the second repeater 203b can connect with one or more BSs and one or more UEs. Thus, the exemplary nodes in the wireless communication system 200 with a limited number should not be deemed as the limitation to the present application.

Referring to FIG. 3, in the exemplary wireless communication system 300, there are multiple nodes, e.g., a gNB 301, a repeater 303 and a UE 305, wherein the gNB 301 is configured with (or associated with) two TRPs, e.g., a first TRP 301a and a second TRP 301b. The repeater 303 is connected with each of the first TRP 301a and the second TRP 301b. Thus, there two links between the gNB 301 and the repeater 303, one is a BS-repeater link (or gNB-repeater link, or TRP-repeater link) between the first TRP 301a and the repeater 303 and the other is a BS-repeater link (or gNB-repeater link, or TRP-repeater link) between the second TRP 301b and the repeater 303.

According to RP-213592, smart repeaters, which are transparent to UEs will be studied and identified. The smart repeaters maintain the BS-repeater link and repeater-UE link simultaneously, and need to determine transmission beam and reception beam for BS-repeater link and repeater-UE link (hereafter, referred to as “repeater beam”). However, in some scenarios, e.g., a RACH procedure or a BFR procedure, the repeater cannot determine beams for the BS-repeater link and repeater-UE link due to lacking beam indication information from the gNB.

Taking a RACH procedure as an example, it is also referred to as a physical random access channel (PRACH) procedure, which includes 4-step RACH procedure and 2-step RACH procedure. In a 4-step RACH procedure, Msg 2, Msg 3 and Msg 4 and corresponding PUCCH feedback will use the same beam selected by the UE (also referred to as “UE beam”) as Msg A. In a 2-step RACH procedure, Msg B and corresponding PUCCH feedback will use the same UE beam as Msg A. The UE beam can be determined by RACH detection at gNB side. However, no indication on the selected UE beam will be transmitted from the gNB to the repeater in legacy technology, and the repeater cannot detect the preamble transmitted by UE. Thus, the repeater does not know the UE beam selected in the RACH procedure, and cannot determine beams for gNB-repeater link and repeater-UE link.

Similarly, in a BFR procedure, PDCCH reception, PDCSH reception and PUCCH transmission will use a candidate beam, e.g., q_new specified in 3GPP specifications selected by the UE. The gNB can know the selected candidate beam because the selected candidate beam is associated with a RO or is reported by the UE in MAC CE. However, no indication on the selected candidate beam will be transmitted from the gNB to the repeater in legacy technology, and the repeater cannot determine the beam based on uplink detection of UE's preamble or MAC CE. Thus, the repeater does not know the candidate beam selected in the BFR procedure, and cannot determine beams for gNB-repeater link and repeater-UE link.

At least to solve the above technical problems, embodiments of the present application propose a technical solution of beam determination, e.g., a method and apparatus of beam determination, so that a RAN node, e.g., a smart repeater can determine beam(s) for the BS-repeater link(s) and beam(s) for the repeater-UE link(s), e.g., in a RACH procedure or BFR procedure. The beam(s) can be transmission beam(s) or reception beam(s) or both of them.

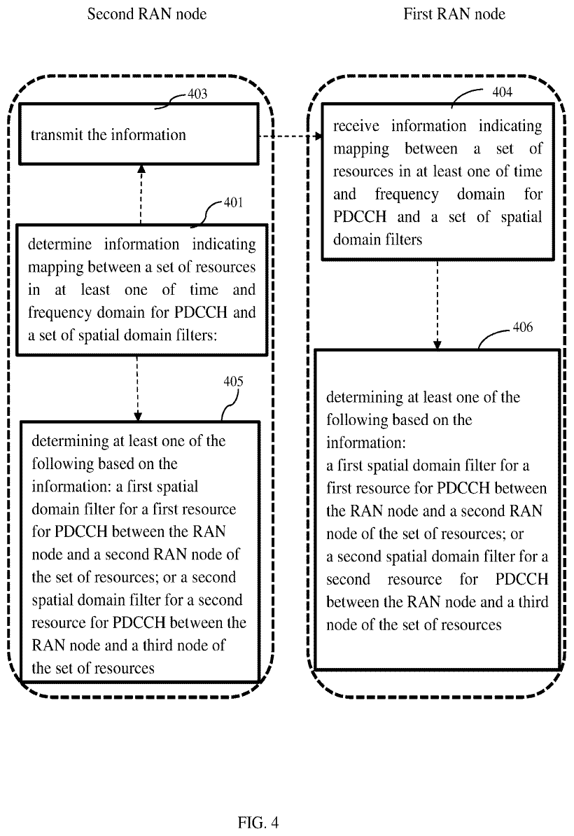

FIG. 4 is a flow chart illustrating an exemplary procedure of a method of beam determination according to some embodiments of the present application. Although the method is illustrated in a system level by a first RAN node, e.g., a repeater and a second RAN node, e.g., a BS, persons skilled in the art should understand that the method implemented in the two RAN nodes can be separately implemented and/or incorporated by other apparatus with the like functions.

As shown in FIG. 4, the first RAN node, e.g., a repeater is deployed between a second RAN node, e.g., a gNB and a third node, e.g., a UE, and may maintain at least one link between the first RAN node and the second RAN node, e.g., at least one BS-repeater link and at least one link between the first RAN node and the third node, e.g., at least one repeater-UE link simultaneously. The second RAN node will provide necessary side control information, e.g., beamforming information to the first RAN node.

Persons skilled in the art should well know that herein, the wordings, such as the first, the second, and the third etc., are only used to distinguish similar features or elements etc., for clearness, and should not be deemed as limitation to the scope of the technical solutions. In addition, each beam for a RAN node or a node, e.g., a UE is associated with a spatial domain filter for transmission or reception (i.e., a spatial domain transmission or reception filter), which is also associated with at least one RS. For example, each beam or spatial domain filter is associated with at least one of: CSI-RS (or CSI-RS resource), or SSB, or SRS (or SRS resource), or TCI state, or joint TCI state, or spatial relation information etc. Each TCI state, or spatial relation information, or joint TCI state for at least one of downlink and uplink may be associated with one or two quasi co-located (QCL)-typeD RSs.

For example, the second node, e.g., the gNB may configure (or determine) information indicating mapping (or association or relationship) between a set of resources in at least one of time and frequency domain for PDCCH and a set of spatial domain filters in step 401. For example, the information can be transmitted via SIB1, RRC. MAC CE or DCI (e.g., group common DCI). In some embodiments of the present application, the information may explicitly or implicitly indicate a starting boundary and a period or even an offset of the mapping. The starting boundary may be a slot boundary of receiving a signaling indicating the information, or is a nearest slot boundary, downlink symbol, or uplink symbol, or an OFDM symbol or a SC-FDMA symbol after receiving the signaling. In some other embodiments of the present application, a signaling separate from that transmitting the information will be transmitted from the second node to the first node, which configures at least one of a starting boundary of the mapping, a period or an offset of the mapping. The at least one of the starting boundary, period or offset is in unit of slot of ms or slot of s. If the unit is a slot, the subcarrier spacing (SCS) to determine the slot can be explicitly configured or implicitly determined based on frequency band, SCS of initial access or SCS of SSB, etc.

A resource in at least one of time or frequency domain may be a time domain resource, a frequency domain resource or a time and frequency domain resource. In addition, a resource in at least one of time or frequency domain for PDCCH can be represented in various. For example, a resource in at least one of time or frequency domain for PDCCH may be a PDCCH monitoring occasion, e.g., a PDCCH monitoring occasion in a search space of random access response or a PDCCH monitoring occasion in a recovery search space in some embodiments of the present application. In some other embodiments of the present application, a resource in at least one of time or frequency domain for PDCCH may be a CORESET for PDCCH or search space for PDCCH. On the other hand, a resource in time domain is one or more symbols, or one or more slots in time domain. For example, a resource in time domain is one or multiple downlink symbols, uplink symbols, OFDM symbols or SC-FDMA symbols. In some scenarios, a resource may indicate no transmission or reception.

Each spatial domain filter can be a transmission spatial domain filter or a reception spatial domain filter, or transmission and reception spatial domain filter. The information may only indicate the mapping between resources for PDCCH and spatial domain filters between the first RAN node and the second RAN node, e.g., for a gNB-repeater link; or only the mapping between resources for PDCCH and spatial domain filters between the first RAN node and the third node, e.g., for a repeater-UE link, or both the mapping between resources for PDCCH and spatial domain filters between the first RAN node and the second RAN node and spatial domain filters between the first RAN node and the third node. In addition, the mapping between resources for PDCCH and spatial domain filters between the first RAN node and the second RAN node, and the mapping between resources for PDCCH and spatial domain filters between the first RAN node and the third node can be included in the information via the same signaling or in different information via separate signaling.

The second node, e.g., the gNB will transmit the configured information to the first node, e.g., the repeater in step 403, and the first node, e.g., the repeater will receive the configured information accordingly in step 404.

Based on the information, beam sweeping will be performed for PDCCH, that is, all repeater beams will be determined in the first node and second node is to transmit different PDCCHs with different beam directions. Each beam can be associated with one or two RSs. For example, the second node, e.g., the gNB may determine at least one of a first spatial domain filter for a first resource for PDCCH between the RAN node and a second RAN node; or a second spatial domain filter for a second resource for PDCCH between the RAN node and the third node in step 405. The first node, e.g., the repeater can also determine at least one of the first spatial domain filter for the first resource for PDCCH between the RAN node and the second RAN node; or a second spatial domain filter for a second resource for PDCCH between the RAN node and the third node in step 406. The first spatial domain filter and the second domain filter can be determined based on the same spatial domain filter or different spatial domain filters.

Hereafter, taking a repeater as an example of the first RAN node, taking a gNB as an example of the second RAN node, and taking a UE as an example of the third node, more details on how to determine beams for PDCCH, e.g., in RACH procedure and BFR procedure by a repeater will be illustrated below in view of various exemplary embodiments of the present application. Persons skilled in the art should well know that the illustrated solutions can also be applied to other nodes with the like functions in a wireless communication system.

In a RACH procedure or BFR procedure, different ROs are associated with different RSs, e.g., SSB or CSI-RS resource in the UE side. Thus, when a UE selects a RO, an uplink transmission beam associated with the RO for RACH selected by the UE (hereafter, UE uplink transmission beam) is determined. Accordingly, in the gNB side, a RO where the RACH transmission occurs is determined by blind detection on ROs, so that the UE uplink transmission beam is determined. Meanwhile, since mapping between RSs and ROs will occur periodically, there can also be beam sweeping in the gNB side to determine the gNB reception beam corresponding to each UE transmission beam. After that, in the RACH procedure, downlink reception such as Msg B or Msg 4 will use the same beam for random access response, that is, the weighting factors for gNB spatial domain transmission filter of Msg B or Msg 4 will be the same as that for gNB spatial domain reception filters of PRACH. Meanwhile, the weighting factors for UE spatial domain reception filter of Msg B or Msg 4 will be the same as that for UE spatial domain transmission filter of PRACH.

When there is a repeater, the gNB can indicate the repeater the beams for PDCCH in the gNB-repeater link or repeater-UE link based on the UE transmission beam and gNB reception beam for PRACH.

According to some embodiments of the present application, a resource for PDCCH is a PDCCH monitoring occasion, and the information indicates the mapping between PDCCH monitoring occasions and spatial domain filters (beams). For a RACH procedure, a random access response will be monitored in a search space of random access response, and multiple PDCCH monitoring occasions associated with the search space of random access response can be associated with different beams. Similarly, for beam failure request carried by RACH, each RO is associated with a candidate beam, and PDCCH in response to the beam failure request is in recovery search space. Accordingly, multiple PDCCH monitoring occasions associated with recovery search space can be associated with different candidate beams.

For example, different PDCCH monitoring occasions are mapped to different spatial domain filters by mapping the PDCCH monitoring occasions to a set of RSs associated with a set of spatial domain filters, wherein the information indicates the mapping between the PDCCH monitoring occasions and RSs associated with the set of spatial domain filters. The RSs may be SSB in a RACH procedure, and may be SSB or CSI-RS resource or SRS resource in a BFR procedure. Taking SSB as an example, SSB indexes transmitted in a cell can be indicated in SIB1 or RRC signaling. The repeater can determine a beam for the gNB-repeater link or repeater-UE link for each PDCCH monitoring occasion based on the associated SSB index. The difference between the mapping for a BFR procedure and that for a RACH procedure is that: for the BFR procedure, the RSs are configured by a candidate beam RS list rather than SSB index configuration in SIB1 or RRC for a RACH procedure. Meanwhile, RO associated with each RS for a BFR procedure is configured by RRC signaling.

The mapping is cyclical in some embodiments of the present application. The mapping can be restarted at each mapping period (or cycle or window or the like). For a RACH procedure, a starting boundary of the mapping is the first PDCCH monitoring occasion in a search space of random access response and is at least 1 symbol after a RO associated with a RS with an index of a set of RSs associated with the set of spatial domain filters. The index can be the smallest among the set of RSs. For a BFR procedure, a starting boundary of the mapping is the first PDCCH monitoring occasion in a recovery search space, and is at least 4 symbols after a RO associated with a RS with a RS index of a candidate RS list associated with the set of spatial domain filters. The RS index can be the smallest one among the set of candidate RSs in the list. In some other embodiments of the present application, the start of the mapping is based on explicit configuration of a period and an offset, which can be transmitted via a signaling separate from the signaling transmitting the information indicating the mapping. The period and offset can be in unit of slot or in unit of ms. If the unit is slot, SCS to determine the slot duration can be explicitly configured or implicitly determined based on frequency band or SCS of SSB.

There may be more than one PDCCH monitoring occasion after a first RO associated with a first RS of a set of RSs associated with the set of spatial domain filters and before a second RO associated with a second RS of the set of RSs. The PDCCH monitoring occasion of the more than one PDCCH monitoring occasion with the lowest time domain index will be mapped to the first RS. For the remaining PDCCH monitoring occasion(s) except for the PDCCH monitoring occasion with the lowest time domain index, it will not be used or will also be mapped to the first RS.

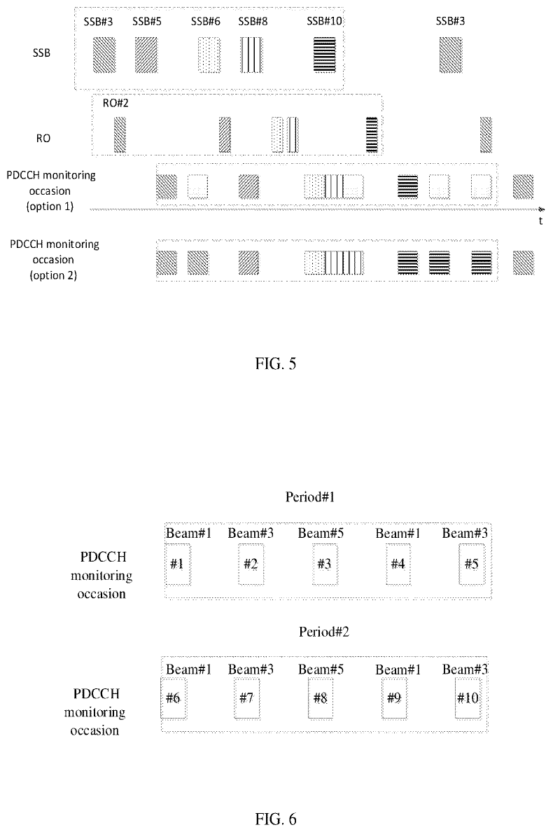

FIG. 5 is a schematic diagram illustrating an exemplary beam determination procedure according to some embodiments of the present application.

As shown in FIG, 5, there are five SSB, e.g., SSB #3, SSB #5, SSB #6, SSB #8. and SSB #10 indicated in RRC signaling, and a RO, e.g., RO #2 is associated with the first SSB. i.e., SSB #3. Based on such mapping information, the PDCCH monitoring occasion associated with SSB #3 is the first PDCCH monitoring occasion, which is at least one symbol after RO #2 in time domain. The subsequent PDCCH monitoring occasions after the first PDCCH monitoring occasion associated with other ROs will be associated with SSB #5, SSB #6, SSB #8, and #10 in sequence and periodically. Although only one entire mapping period is shown in FIG. 5, persons skilled in the art should well know how to map the following PDCCH monitoring occasions to the five SSB in other periods.

However, there is more than one PDCCH monitoring occasion (also referred to as additional PDCCH monitoring occasion) after a RO associated with a SSB, e.g., SSB #3 and before another RO associated with another SSB following the SSB, e.g., SSB #5. There can be multiple options. According to option 1, the additional PDCCH monitoring occasion will be unused. According to option 2, the additional PDCCH monitoring occasion will be used and also be associated with SSB #3. Similarly, for the additional PDCCH monitoring occasion after the RO associated with SSB #8 and before RO associated with SSB #10, and the additional PDCCH monitoring occasions after the RO associated with SSB #10 and before RO associated with SSB #1 in the next period, they will be unused according to option 1 and will be associated with the nearest previous SSB (SSB #10) according to option 2.

According to some other embodiments of the present application, resources for PDCCH are mapped to a set of spatial domain filters by mapping a set of CORESETs for PDCCH to a set of RSs associated with the set of spatial domain filters, and the information indicates the mapping between the set of CORESETs and the set of RSs. For example, more than one CORESET will be configured for PDCCH associated with random access or PDCCH monitoring associated with BFR. Different CORESETs are associated with different SSB or CSI-RS resources, e.g., CORESET #1 being associated with the first SSB index, CORESET #2 is associated with the second SSB index, and so on. The repeater can determine a beam for at least one of the gNB-repeater link and repeater-UE link for each CORESET based on the associated SSB index.

According to some yet other embodiments of the present application, resources for PDCCH are mapped to a set of spatial domain filters by mapping a set of search spaces for PDCCH to a set of RSs associated with the set of spatial domain filters, and the information indicates the mapping between the set of search spaces and the set of RSs. For example, more than one search space will be configured for PDCCH associated with random access or PDCCH monitoring associated with BFR, and different search spaces are associated with different SSB or CSI-RS resources, e.g., search space #1 being associated with the first SSB index, search space #2 being associated with the second SSB index, and so on. The repeater can determine a beam for at least one of the gNB-repeater link and repeater-UE link for each search space based on the associated SSB index.

According to some yet other embodiments of the present application, resources for PDCCH are mapped to a set of spatial domain filters by mapping a set of CCEs for PDCCH candidates to a set of RSs associated with the set of spatial domain filters, and the information indicates the mapping between the CCEs of the PDCCH candidates and the set of RSs. The mapping is determined by a CCE with the lowest index of a corresponding PDCCH candidate. For example, for PDCCH monitoring associated with random access or beam failure recovery. Different lowest CCE indexes of different PDCCH candidates can be associated with different SSB or CSI-RS resources, e.g., CCE #0 being associated with the first SSB index, CCE #8 is associated with the second SSB index, and so on.

In some embodiments of the present application, the gNB may indicate the repeater a beam pattern via signaling, indicating the mapping between resources for PDCCH and beams in a period or window. The beam pattern contains one or more beams. Exemplary signaling is SIB1, RRC. MAC CE or group common DCI etc. The group common DCI is associated with a CORESET and a search space.

The set of spatial domain filters will be mapped to corresponding resources, e.g., PDCCH monitoring occasions or corresponding CORESETs or corresponding search spaces one by one in sequence and cyclically according to the beam pattern. When the number, e.g., N of resources (e.g., PDCCH monitoring occasions) is smaller than the number e.g., M of beams in the beam pattern, only the first N beams are mapped to PDCCH monitoring occasions. When the number e.g., N of resources (e.g., PDCCH monitoring occasions) is larger than the number e.g., M of beams in the beam pattern, a resource with index #K satisfying K mod M=0 is mapped to the first beam, a resource with index (K+1) is mapped to the second beam in the beam pattern, and so on.

There can be a beam in the beam pattern indicates that no transmission or reception is necessary at the repeater. In addition, there can also be only one beam in the beam pattern, and the only beam is applied to all PDCCH monitoring occasions or D symbols, D slots or slots in the configured period or window of the beam pattern.

Start of the mapping based on the beam pattern may be explicitly configured, or is implicitly indicated. For example, the start of the mapping based on the beam pattern can be a slot boundary of the signaling indicating the beam pattern, the nearest slot boundary after receiving the signaling, or the nearest PDCCH monitoring occasion after receiving the signaling, the nearest CORESET after receiving the signaling or the nearest search space after receiving the signaling. The duration of the period or window of the beam pattern can be explicitly configured, e.g., in unit of PDCCH monitor occasion or in unit of slot or ms or symbol etc.

Exemplary start of the beam pattern can be the nearest D (downlink) or U (uplink) symbol or slot after receiving the signaling indicating the beam pattern. For a slot, if it contains at least one downlink symbol, it can be considered as downlink slot. For a slot, if it contains at least one uplink symbol, it can be considered as uplink slot. The repeater can determine whether a slot or a symbol is for downlink, uplink or flexible based on RRC signaling from the gNB. The repeater can determine that the beam pattern is only applied to downlink slots or downlink symbols, or uplink slots or uplink symbols or both downlink and uplink slots or symbols. Beams for gNB-repeater link and/or repeater-UE link for downlink slots or symbols and uplink slots or uplink symbols can be separate or jointly configured.

In the case of joint configuration, if a slot is a downlink slot or the slot contains downlink symbols only, the beam for gNB-repeater link and/or repeater-UE link, i.e., repeater beam is the reception beam in gNB-repeater link and transmission beam in repeater-UE link. If a slot is an uplink slot or the slot contains uplink symbols only, the repeater beam is the reception beam in repeater-UE link and transmission beam in gNB-repeater link. If the slot contains both downlink and uplink symbols, the repeater beam for downlink symbols is the reception beam in gNB-repeater link, and the transmission beam in repeater-UE link, and the repeater beam for uplink symbols is the reception beam in repeater-UE link and the transmission beam in gNB-repeater link.

Exemplary beam determination procedures based on beam pattern according to some embodiments of the present application are illustrated in FIGS. 6 to 9.

Regarding FIG. 6, it is a schematic diagram illustrating an exemplary beam determination procedure based on beam pattern according to some embodiments of the present application.

In the scenario shown in FIG. 6, the exemplary beam pattern contains three beams, e.g., beam #1, beam #3 and beam #5, while there are 5 PDCCH monitoring occasions within the period or window of the beam pattern, e.g., PDCCH monitoring occasions #1, #2, #3, #4 and #5 within period #1 and PDCCH monitoring occasions #6, #7, #8, #9 and #10 within period #2. That is, the number N of PDCCH monitoring occasions is larger than the number M of beams within the period of the beam pattern. Then, for each PDCCH monitoring occasion with index #K, K mod M=0 is mapped to the first beam, index (K+1) is mapped to the second beam in the beam pattern, and so on. Accordingly, the five PDCCH monitoring occasions are respectively mapped to beam #1, beam #3, beam #5, beam #1 and beam #3 in sequence within each period and will be periodically applied to each period. Although two periods, e.g., period #1 and period #2 are shown, persons skilled in the art should well know how to map other following PDCCH monitoring occasions to beams based on the beam pattern.

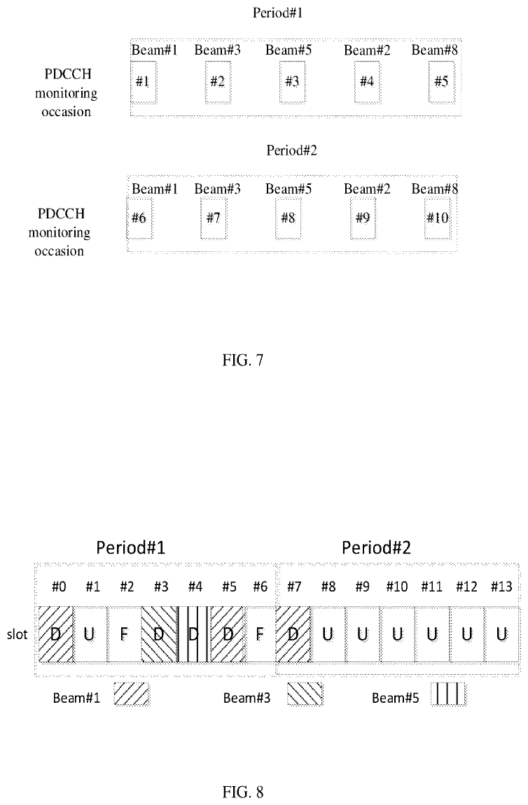

Regarding FIG. 7, it is a schematic diagram illustrating an exemplary beam determination procedure based on beam pattern according to some other embodiments of the present application.

In the scenario shown in FIG. 7, the exemplary beam pattern contains 6 beams, e.g., beam #1, beam #3, beam #5, beam #2, beam #8 and beam #10, while there are only 5 PDCCH monitoring occasions within the period or window of the beam pattern, e.g., PDCCH monitoring occasions #1, #2, #3, #4 and #5 within period #1 and PDCCH monitoring occasions #6, #7, #8, #9 and #10 within period #2. That is, the number N of PDCCH monitoring occasions is smaller than the number M of beams within the period of the beam pattern. Then, only the first 5 beams are mapped to PDCCH monitoring occasions. Accordingly, the five PDCCH monitoring occasions are respectively mapped to beam #1, beam #3, beam #5, beam #2 and beam #8 in sequence within each period and will be periodically to each period. Beam #10 will not be used. Although two periods, e.g., period #1 and period #2 are shown, persons skilled in the art should well know how to map other following PDCCH monitoring occasions to beams based on the beam pattern.

Regarding FIG. 8, it is a schematic diagram illustrating an exemplary beam determination procedure based on beam pattern according to some yet other embodiments of the present application.

In the scenario shown in FIG. 8, the exemplary beam pattern contains three beams, e.g., beam #1, beam #3 and beam #5, while there are 7 slots within the period or window of the beam pattern, e.g., slots #0, #1, #2, #3, #4, #5 and #6 within period #1 and slots #7, #8, #9, #10, #11, #12 and #13 within period #2. In addition, the beam pattern is only applied to downlink slots. Since the number of downlink slots is larger than the number of beams within the period of the beam pattern, for each slot with index #K, K mod 3=0 is mapped to the first beam, index (K+1) is mapped to the second beam in the beam pattern, and so on. Accordingly, 4 downlink slots are respectively mapped to beam #1, beam #3, beam #5, and beam #1 in sequence for period #1. For period #2, there is only downlink slots, so only beam #1 is mapped to the downlink slot, and other beams are not used. Although two periods, e.g., period #1 and period #2 are shown, persons skilled in the art should well know how to map other following D slots to beams based on the beam pattern.

Regarding FIG. 9, it is a schematic diagram illustrating an exemplary beam determination procedure based on beam pattern according to some yet other embodiments of the present application.

In the scenario shown in FIG. 9, the exemplary beam pattern contains three beams, e.g., beam #1, beam #3 and beam #5, while there are 7 slots within the period or window of the beam pattern. In addition, the beam pattern is applied to both downlink slot and uplink slot jointly. Since the number of downlink slots and uplink slots is larger than the number of beams within the period of the beam pattern, for each slot with index #K, K mod 3=0 is mapped to the first beam, index (K+1) is mapped to the second beam in the beam pattern, and so on. Accordingly, 5 downlink slots and uplink slots are respectively mapped to beam #1, beam #3, beam #5, beam #1 and beam #3 in sequence for period #1. For period #2, the mapping to downlink and uplink slots will be beam #1, beam #3, beam #5, beam #1, beam #3, beam #5, and beam #1. The mapping to each period is determined by both the number of beams and the number of downlink slots, the number of uplink slots or both. Although two periods, e.g., period #1 and period #2 are shown, persons skilled in the art should well know how to map other following D slots and U slots to beams based on the beam pattern.

According to some embodiments of the present application, based on spatial domain filter of a detected PDCCH reception in a search space of random access response, a spatial domain filter will be determined for at least one of PDSCH, Msg B, or Msg 4, or PUCCH in response to Msg B or Msg 4 reception between the gNB and repeater. Based on a spatial domain filter of detected PDCCH reception in the search space of random access response, a spatial domain filter will be determined for at least one of PDSCH, or Msg B, or Msg 4, or PUCCH in response to Msg B or Msg 4 transmission between the repeater and UE.

For example, in a contention based RACH procedure, based on the relationship between PDCCH monitoring occasion and repeater beam, a PDCCH in a search space of random access response can be detected in time domain, and the corresponding beam used for PRACH transmission can be determined. The beam used for PRACH transmission can be associated with a SSB.

After that, the repeater beam for corresponding PDSCH is determined based on the beam for PDCCH reception, or the repeater beam for PUCCH transmission is determined based on the beam used for PDCCH reception, or the repeater beam for Msg B or Msg 4 (i.e., DCI in response to PUSCH scheduled by random access response uplink grant) is determined based on the beam used for PDCCH reception, or all of the above repeater beams can be determined.

For a PDCCH order triggered RACH procedure, if the contention free random access procedure is for special cell (SpCell), then the repeater beam for PDCCH corresponding to this RACH procedure is the same as the repeater beam for PDCCH order. Regarding Spcell, it refers to the PCell of master cell group (MCG) and the primary secondary cell (PSCell) of secondary cell group (SCG). If the contention free random access procedure is for a secondary cell, then the repeater beam for PDCCH is the same as the repeater beam for the CORESET associated with the Type1-PDCCH common search space (CSS) set.

Similarly, based on a spatial domain filter of detected PDCCH transmission in the recovery search space, a spatial domain filter will be determined for one or more of CORESET #0, all CORESETs on Scells, PUCCH on a Pcell, and all PUCCH on a PUCCH-Scell for transmission between the gNB and repeater. Based on a spatial domain filter of detected PDCCH reception in the recovery search space, a spatial domain filter will be determined for one or more of CORESET #0, all CORESETs on Scells, PUCCH on Pcell, and all PUCCH on a PUCCH-Scell for reception between the repeater and UE.

For example, in a BFR procedure, based on the relationship between PDCCH monitoring occasion and repeater beam, a PDCCH in a recovery search space can be detected in time domain, and corresponding candidate beam, e.g., q_new can be determined.

Then, after multiple symbols, e.g., 28 symbols from the last symbol of the first PDCCH reception, the repeater beam for UE transmitted PUCCH is determined based on q_new or the detected PDCCH, or the repeater beam for CORESET #0 is determined based on the detected PDCCH or q_new, or the repeater beam for all CORESETs on Scells is determined based on the detected PDCCH or q_new, or the repeater beam for all PUCCH on a PUCCH-Scell is based on the detected PDCCH or q_new, or all of the above repeater beams are determined based on the detected PDCCH or q_new.

Besides the methods, embodiments of the present application also propose an apparatus of beam indication.

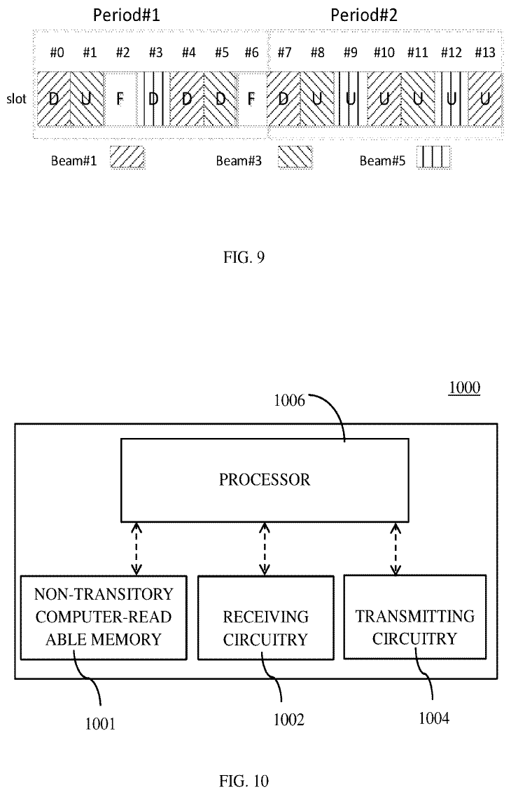

For example, FIG. 10 illustrates a block diagram of an apparatus of beam determination 1000 according to some embodiments of the present application.

As shown in FIG. 10, the apparatus 1000 may include at least one non-transitory computer-readable medium 1001, at least one receiving circuitry 1002, at least one transmitting circuitry 1004, and at least one processor 1006 coupled to the non-transitory computer-readable medium 1001, the receiving circuitry 1002 and the transmitting circuitry 1004. The at least one processor 1006 may be a CPU, a DSP, a microprocessor etc. The apparatus 1000 may be a RAN node, e.g., a gNB or a repeater configured to perform a method illustrated in the above or the like.

Although in this figure, elements such as the at least one processor 1006, transmitting circuitry 1004, and receiving circuitry 1002 are described in the singular, the plural is contemplated unless a limitation to the singular is explicitly stated. In some embodiments of the present application, the receiving circuitry 1002 and the transmitting circuitry 1004 can be combined into a single device, such as a transceiver. In certain embodiments of the present application, the apparatus 1000 may further include an input device, a memory, and/or other components.

In some embodiments of the present application, the non-transitory computer-readable medium 1001 may have stored thereon computer-executable instructions to cause a processor to implement the method with respect to the first RAN node as described above. For example, the computer-executable instructions, when executed, cause the processor 1006 interacting with receiving circuitry 1002 and transmitting circuitry 1004, so as to perform the steps with respect to the first RAN node as depicted above.

In some embodiments of the present application, the non-transitory computer-readable medium 1001 may have stored thereon computer-executable instructions to cause a processor to implement the method with respect to the second RAN node as described above. For example, the computer-executable instructions, when executed, cause the processor 1006 interacting with receiving circuitry 1002 and transmitting circuitry 1004, so as to perform the steps with respect to the second RAN node as illustrated above.

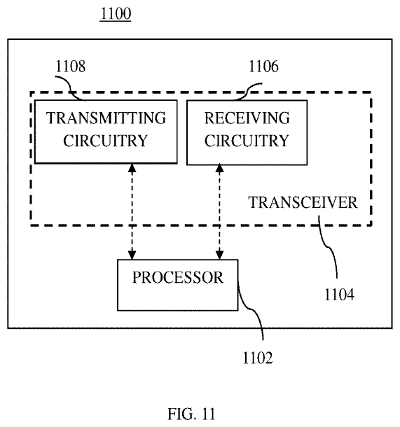

FIG. 11 is a block diagram of an apparatus of beam determination 1100 according to some other embodiments of the present application.

Referring to FIG. 11, the apparatus 1100, for example a gNB or a repeater may include at least one processor 1102 and at least one transceiver 1104 coupled to the at least one processor 1102. The transceiver 1104 may include at least one separate receiving circuitry 1106 and transmitting circuitry 1104, or at least one integrated receiving circuitry 1106 and transmitting circuitry 1104. The at least one processor 1102 may be a CPU, a DSP, a microprocessor etc.

According to some embodiments of the present application, when the apparatus 1100 is a first RAN node, e.g., a repeater, the processor is configured to: receive, via the transceiver, information indicating mapping between a set of resources in at least one of time and frequency domain for PDCCH and a set of spatial domain filters; and determine at least one of the following based on the information: a first spatial domain filter for a first resource for PDCCH between the RAN node and a second RAN node of the set of resources; or a second spatial domain filter for a second resource for PDCCH between the RAN node and a third node of the set of resources.

According to some other embodiments of the present application, when the apparatus 1100 is a second RAN node, e.g., gNB, the processor may be configured to: determine information indicating mapping between a set of resources in at least one of time and frequency domain for PDCCH and a set of spatial domain filters; transmit the information via the transceiver; and determine at least one of the following based on the information: a first spatial domain filter for a first resource for PDCCH between the RAN node and a first RAN node of the set of resources; or a second spatial domain filter for a second resource for PDCCH between the first RAN node and a third node of the set of resources.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A first radio access network (RAN) node, comprising:
at least one memory; and
at least one processor coupled with the at least one memory and configured to cause the first RAN node to:
receive information indicating mapping between a set of resources in at least one of time and frequency domain for physical downlink control channel (PDCCH) and a set of spatial domain filters; and
determine, based on the information, at least one of:
a first spatial domain filter for a first resource for PDCCH between the first RAN node and a second RAN node of the set of resources; or
a second spatial domain filter for a second resource for PDCCH between the first RAN node and a third node of the set of resources.

2. The first RAN node of claim 1, wherein a spatial domain filter of the spatial domain filter sets is associated with a synchronization signal (SS)/physical broadcast channel (PBCH) block (SSB), a channel state information-reference signal (CSI-RS) resource or a sounding reference signal (SRS) resource.

3. The first RAN node of claim 1, wherein the information further indicates a starting boundary and a period of the mapping.

4. The first RAN node of claim 1, wherein a resource of the set of resources is a PDCCH monitoring occasion.

5. The first RAN node of claim 1, wherein the PDCCH is associated with a search space of random access response or a recovery search space.

6. The first RAN node of claim 4, wherein different resources of the set of resources are mapped to different spatial domain filters by mapping the set of resources to a set of reference signals (RSs) associated with the set of spatial domain filters, and the information indicates mapping between the set of resources and the set of spatial domain filters.

7. The first RAN node of claim 1, wherein the set of resources is mapped to the set of spatial domain filters by mapping a set of control resource sets (CORESETs) for PDCCH to a set of reference signals (RSs) associated with the set of spatial domain filters, and the information indicates the mapping between the set of CORESETs and the set of RSs.

8. The first RAN node of claim 1, wherein the set of resources is mapped to the set of spatial domain filters by mapping a set of search spaces for PDCCH to a set of reference signals (RSs) associated with the set of spatial domain filters, and the information indicates the mapping between the set of search spaces and the set of RSs.

9. The first RAN node of claim 1, wherein the set of resources is mapped to the set of spatial domain filters by mapping a set of control channel elements (CCE)s for PDCCH candidates to a set of reference signals (RSs) associated with the set of spatial domain filters, and the information indicates the mapping between the PDCCH candidates and the set of RSs, wherein the mapping is determined by a CCE with a lowest index of a corresponding PDCCH candidate.

10. The first RAN node of claim 1, wherein the at least one processor is further configured to cause the first RAN node to perform at least one of:
determine a third spatial domain filter for at least one of physical downlink shared channel (PDSCH), Msg B, or Msg 4, or physical uplink shared channel (PUCCH) in response to Msg B or Msg 4 reception between the first RAN node and the second RAN node based on the first spatial domain filter, wherein the first domain filter is a spatial domain filter of a detected PDCCH reception in a search space of random access response; or
determine a fourth spatial domain filter for at least one of PDSCH, or Msg B, or Msg 4, or PUCCH in response to MsgB or Msg 4 transmission between the first RAN node and the third node based on a spatial domain filter of the second spatial domain filter, wherein the second spatial domain filter is a detected PDCCH transmission in the search space of random access response.

11. The first RAN node of claim 1, wherein the at least one processor is further configured to cause the first RAN node to perform at least one of:
determine a third spatial domain filter for one or more of control resource set (CORESET) #0, all CORESETs on secondary cells (Scells), physical uplink control channel (PUCCH) on a primary cell (Pcell), and all PUCCH on a PUCCH-Scell for transmission between the first RAN node and the second RAN node based on the first spatial domain filter, wherein the first spatial domain filter is a spatial domain filter of detected PDCCH transmission in a recovery search space; or
determine a fourth spatial domain filter for one or more of CORESET #0, all CORESETs on Scells, PUCCH on Pcell, and all PUCCH on a PUCCH-Scell for reception between the first RAN node and the third node based on the second spatial domain filter, wherein the second spatial domain filter is a spatial domain filter of detected PDCCH reception in the recovery search space.

12. The first RAN node of claim 1, wherein the at least one processor is further configured to cause the first RAN node to receive a signaling configuring at least one of a starting boundary of the mapping, a period or an offset of the mapping.

13. The first RAN node of claim 12, wherein the at least one of the starting boundary, the period, or the offset is in unit of slot of ms or slot of s.

14. A first A radio access network (RAN) node, comprising:
at least one memory; and
at least one processor coupled with the at least one memory and configured to cause the first RAN node to:
determine information indicating mapping between a set of resources in at least one of time and frequency domain for physical downlink control channel (PDCCH) and a set of spatial domain filters;
transmit the information; and
determine, based on the information, at least one of:
a first spatial domain filter for a first resource for PDCCH between the first RAN node and a second RAN node of the set of resources; or
a second spatial domain filter for a second resource for PDCCH between the first RAN node and a third node of the set of resources.

15. A method performed by a first radio access network (RAN) node, the method comprising:
receiving information indicating mapping between a set of resources in at least one of time and frequency domain for physical downlink control channel (PDCCH) and a set of spatial domain filters; and
determining, based on the information, at least one of:
a first spatial domain filter for a first resource for PDCCH between the first RAN node and a second RAN node of the set of resources; or
a second spatial domain filter for a second resource for PDCCH between the first RAN node and a third node of the set of resources.

16. The method of claim 15, wherein a spatial domain filter of the spatial domain filter sets is associated with a synchronization signal (SS)/physical broadcast channel (PBCH) block (SSB), a channel state information-reference signal (CSI-RS) resource or a sounding reference signal (SRS) resource.

17. The method of claim 15, wherein the information further indicates a starting boundary and a period of the mapping.

18. A method performed by a first radio access network (RAN) node, the method comprising:
determining information indicating mapping between a set of resources in at least one of time and frequency domain for physical downlink control channel (PDCCH) and a set of spatial domain filters;
transmitting the information; and
determining, based on the information, at least one of:
a first spatial domain filter for a first resource for PDCCH between the first RAN node and a second RAN node of the set of resources; or
a second spatial domain filter for a second resource for PDCCH between the first RAN node and a third node of the set of resources.

19. The method of claim 18, wherein the information further indicates a starting boundary and a period of the mapping.

20. The first RAN node of claim 14, wherein the information further indicates a starting boundary and a period of the mapping.
